(19) United States
(12) Patent Application Publication
(10) Pub. No.: US 2015/0004343 A1
(43) Pub. Date: Jan. 1, 2015

(54) POLYOLEFIN FLAME RETARDANT COMPOSITION AND SYNERGISTS THEREOF

(71) Applicant: ICL-IP America Inc., Ardsley, NY (US)

(72) Inventors: Sergei V. Levchick, Croton-on-Hudson, NY (US); Joseph Zilbermann, Haifa (IL); Anantha Desikan, Yorktown Heights, NY (US); Gerald R. Alessio, Enerson, NJ (US)

(21) Appl. No.: 14/374,649

(22) PCT Filed: Jan. 30, 2013
(86) PCT No.: PCT/US2013/023768

§ 371 Date: Jul. 25, 2014

Related U.S. Application Data
(60) Provisional application No. 61/593,491, filed on Feb. 1, 2012.

(51) Int. Cl. C08K 5/5333; C08K 3/22; C08K 3/00

(52) U.S. Cl. CPC C08K 5/5333; C08K 3/0058; C08K 3/22; C08K 2003/2227
USPC 428/36.9; 524/130

(57) ABSTRACT

There is provided herein a flame-retarded polyolefin composition comprising a thermoplastic polyolefin, an inorganic flame retardant filler and a metal phosphonate or metal phosphinate synergist of the general formula (A): where Me is a metal, R¹ and R² are the same or different linear or branched or cyclic alkyls having up to 6 carbon atoms, or benzyl, n is a metal valency and can be, 1, 2, 3 or 4, x is 1 for metal phosphonates and x is 0 for metal phosphinates. There is also provided a method for making a flame-retarded polyolefin composition comprising contacting at least one thermoplastic polyolefin polymer with at least one inorganic flame retardant filler and at least one metal phosphonate or metal phosphinate synergist and heating the mixture to above the melting temperature of the thermoplastic polyolefin.

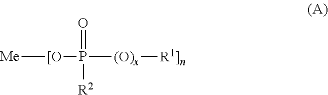

This application claims priority to U.S. Provisional Application No. 61/593,491 filed on Feb. 1, 2012.

### FIELD OF THE INVENTION

The present invention relates to a flame retardant compositions and more particularly to a combination of mineral flame retardant and synergist consisting of metal phosphonate or metal phosphinate. Such compositions are suitable for manufacturing of cable insulation and jackets, tubings, extruded film and/or sheets useful for construction and building materials as well as molded automotive parts and electronic parts.

### BACKGROUND OF THE INVENTION

Polyolefins are represented by two high volume thermoplastic polymers polyethylene and polypropylene, as well as a large number of ethylene-propylene copolymers as well as copolymers with other alkylene monomers. By varying the ratio of low alkylene to higher alkylene comonomers a broad range of polymers from thermoplastics to elastomers can be produced. Similarly ethylene can be copolymerized with vinyl acetate or ethyl acrylate. This reduces the crystallinity of polyethylene and results in products having characteristics of thermoplastic elastomers.

Polyolefin resin is widely used in the production of wire and cable jacketings, tubes, air ducts, thermal insulation systems, computer cabinets, electrical appliances, household interior decorations, sockets for decorative lamps and automobile parts among many other items. They are the polymers of choice due to their good processing characteristics, chemical resistance, weathering resistance, electrical properties and mechanical strength. One major disadvantage is that all polyolefins are very flammable. This flammability has generated a growing demand for flame retarded polyolefins.

For wire and cable applications, halogen-free flame retardant materials are desirable to provide both insulation and jacketing in cables in areas where it is necessary to avoid the generation of corrosive gases in the event of fire. Such areas where halogen-free cables are useful include underground transportation and tunnels, communication centers, hotels, hospitals, schools, theaters and other such public spaces. Jacketing materials have to be highly flame retardant, have good heat performance and good physical properties.

The use of mineral fillers to provide flame retardancy to polyolefins has long been known. Metal hydroxides, especially aluminium hydroxides (such as for example alumina trihydrate (ATH)) and magnesium hydroxides (such as for example magnesium hydroxide (MDH)), have been used as mineral fillers in this context. The metal hydroxides are used alone or in combination with one another and sometimes in combination with other flameproofing additives, such as including inorganic borates which help to stabilize char.

A preferable amount of each of the above metal hydroxides to be blended is 30 to 75 percent by weight of ethylene polymer. If the amount is less than 30 percent by weight, sufficient flame retardancy cannot be obtained. If the amount is more than 75 percent by weight, the physical properties such as elongation of the polymer is significantly reduced.

The flame retardant action of metal hydroxides is based essentially on endothermic decomposition, release of water, a dilution effect of the polymer matrix and to formation of a solid metal oxide-carbonaceous char layer, leading to a certain degree of mechanical stabilization of the burning polymer. This can for example reduce or even completely prevent the production of burning drips. Furthermore, the encrusted char on the surface of the burning polymer acts as a “protective barrier” for the underlying polymer layers, which may prevent rapid propagation of combustion. Therefore improvement of the quality of the char in terms of producing a polymer which when charred is in the absence of cracks and has a uniform cohesive surface is desirable.

### SUMMARY OF THE INVENTION

According to the present invention there is provided herein a flame-retarded polyolefin composition comprising a blend of the following components:

(a) a thermoplastic polyolefin;
(b) an inorganic flame retardant filler;
(c) a metal phosphonate or metal phosphinate synergist and, optionally, further comprising common additives including for example coupling agents, antioxidants, titanium dioxide (for UV resistance and to give a white color to the product), processing aids like zinc stearate and UV stabilizers.

The present invention provides a flame-retarded polyolefin composition which is capable of forming extruded cable insulation, jackets, sheets or films or molded parts which are flame retardant and show low heat release rate, low smoke and when burned produce a smooth, crack-free and uniform char. This flame-retarded polyolefin composition can be used in wire and cables, building construction applications or for production of electrical or electronic parts, appliances and automotive parts.

The thermoplastic polyolefin (a) used herein can be any polyolefin resin, but more preferably an ethylene vinyl acetate containing 25-90% by weight ethylene and 10-75% by weight vinyl acetate, a linear low density polyethylene (LLDPE), a low density polyethylene (LDPE), a very low density polyethylene (VLDPE), a high density polyethylene (HDPE), and mixtures thereof;

The inorganic flame retardant filler (b) can be any metal hydroxide such as magnesium hydroxide (Mg(OH)₂) MDH, aluminum hydroxide (Al(OH)₃) ATH, magnesium basic carbonate, hydrotalcite, calcium aluminate hydrate or similar.

The metal phosphonate or metal phosphinate synergist (c) used herein can be any metal phosphonate or phosphinate represented by the formula:

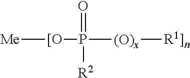

where Me is a metal, R¹ and R² are the same or different linear or branched or cyclic alkyls having up to 6 carbon atoms, or benzyl, n is a metal valency and can be, 1, 2, 3 or 4, x is 1 for metal phosphonates and x is 0 for metal phosphinates.

Metals (Me) which can be present in a metal phosphonate or phosphinate include alkaline earth or transitionary metals such as the non-limiting group consisting of Ca, Zn, Al, Fe, Ti and combinations thereof. The most preferable metal is Al.

Preferably inorganic flame retardant filler (b) is present in the amount from 20 to about 60 weight percent of the total weight of the flame-retarded polyolefin composition. Preferably synergist (c) is present in an amount of from 1 to about 25 weight percent based on the total weight of the flame-retarded polyolefin composition. Preferably the flame retardant package of inorganic flame retardant (b) plus synergist (c) are present in an amount of from 30 to about 75 weight percent based on the total weight of the flame-retarded polyolefin composition.

In another specific application of the invention, the flame-retarded polyolefin polymer composition herein can be further cross-linked in order to improve dimensional stability. Techniques of cross-linking polyolefins are well known in the art with most common being free-radical cross-linking, radiation cross-linking or moisture cure cross-linking using alkoxysilyl-grafted polyolefin. Cross-linked polyolefins can be used in the production of cable jackets and tubing.

The invention herein also comprises articles such as extruded polyolefin sheets or injection molded parts which comprise the flame-retarded polyolefin composition described herein.

The invention comprises a method for making a flame-retarded polyolefin composition by contacting at least one thermoplastic polyolefin polymer (a) with at least one inorganic flame retardant (b) and at least one metal phosphonate or metal phosphinate (c) such as those described herein, and heating the mixture to above the melting temperature of the thermoplastic polyolefin polymer (a). The invention further comprises a method for producing thermoplastic polyolefin insulation or jackets, tubes, sheets or injected molded polyolefin parts which comprises contacting at least one thermoplastic polyolefin polymer with at least one inorganic flame retardant and at least one metal phosphonate or metal phosphinate such as those described herein, and heating the mixture to above the melting temperature of the thermoplastic polyolefin polymer and forming cable insulation or jackets or tubes or sheets or injected molded polyolefin parts therefrom.

### DETAILED DESCRIPTION OF THE PREFERRED EMBODIMENTS

In the practice of the present invention, a flame-retarded polyolefin composition is prepared which is broadly composed of a mixture of the herein-described compounds. A polyolefin resin of essentially any grade can be selected as the polyolefin polymer according to the desired performance requirements such as formability and mechanical properties, including stiffness, heat resistance, and the like of the resulting polyolefin polymer composition.

The thermoplastic polyolefin polymer (a) is preferably at least one of a polyethylene homopolymer, polyethylene copolymer, polypropylene homopolymer, and polypropylene copolymer. In one embodiment, the polyolefin polymer (a) is high-density polyethylene, low-density polyethylene or linear low density polyethylene. Amorphous, crystalline and elastomeric forms of polypropylene can be applied in this invention. Examples of the copolymers which can be used as the polyolefin polymer (a) are at least one of, such as, but not limited to, ethylene-vinyl acetate (EVA); ethylene-propylene rubber (EPR); ethylene-propylene-diene-monomer rubber (EPDM); and, copolymers of ethylene and propylene with butene-1, pentene-1, 3-methylbutene-1, 4-methylpentene-1, octene-1 and mixtures thereof.

Ethylene polymers are more often used in production of cable jacketing and tubing and they include as the main component, low-density polyethylene (LDPE), linear low-density polyethylene (LLDPE), linear very low-density polyethylene (VLDPE), high-density polyethylene (HDPE), ethylene-methyl methacrylate (EMMA) copolymer, ethylene methyl acrylate (EMA) copolymer, ethylene ethyl acrylate (EEA) copolymer, ethylene butyl acrylate (EBA) copolymer, ethylene vinyl acetate (EVA) copolymer, ethylene glycidyl methacrylate copolymer, ethylene-butene-1 copolymer, ethylene-butene-hexene terpolymer, ethylene propylene diene terpolymer (EPDM), ethylene-octene copolymer (EOR), ethylene copolymerized polypropylene (random PP or block PP), ethylene propylene (EPR) copolymer, poly-4-methyl-pentene-1, maleic anhydride grafted low-density polyethylene, hydrogenated styrene-butadiene (H-SBR) copolymer, maleic anhydride grafted linear low-density polyethylene, maleic anhydride grafted linear very low-density polyethylene, copolymers of ethylene and α-olefine with a carbon number of 4 to 20, ethylene-styrene copolymer, maleic anhydride grafted ethylene-styrene copolymer, maleic anhydride grafted ethylene-methyl acrylate copolymer, maleic anhydride grafted ethylene-vinyl acetate copolymer, ethylene-maleic anhydride copolymer, ethylene-ethyl acrylate-maleic anhydride terpolymer, and ethylene-propylene-butene-1 terpolymer including butene-1. These compounds may be used individually. Alternatively, two or more types of them may be blended.

The thermoplastic polyolefin polymer (a) is preferably applied in the pellet form having a melting point in the range of from about 150 to about 250 Celsius (C), most preferably from about 175 C to about 230 C. The thermoplastic polyolefin polymer (a) preferably has a specific gravity in the range of from about 0.85 to about 1.2 and most preferably about 0.90-1.0. The polyolefin resin of choice preferably has a melt flow rate in the range of from about 0.2 to about 30 g/10 min., and more preferably, from about 1 to about 12 g/10 min.

The thermoplastic polyolefin polymer (a) is preferably present in the flame-retarded polyolefin polymer composition in a range from 25 to 70 wt. %, more preferably from 30 to 50 wt. % based on the total weight of the flame-retarded polyolefin composition.

Suitable inorganic flame retardant fillers (b) are known in the art. Specific, preferred inorganic flame retardant fillers include magnesium hydroxide (Mg(OH)₂), aluminum hydroxide (Al(OH)₃), boehmite, hydrotalcite, basic magnesium carbonate, calcium aluminate hydrate, talc and clay. Of these types of flame retardants, aluminum hydroxide is the most preferable, because of relatively low cost and high flame retardant efficiency. Magnesium hydroxide has also good flame retardant efficiency and it is more thermally stable. Magnesium hydroxide flame retardants include synthesized magnesium hydroxide and natural magnesium hydroxide obtained by crushing brucite ores.

From the viewpoints of mechanical properties, ease of dispersion and flame retardancy, the above inorganic flame retardant fillers are more preferable when an average particle diameter of the filler is 10 μm or less and when a ratio of coarse particles with a particle diameter of 25 μm or more is 10% or less to the total filler. It is also possible to increase water resistance by treating the surfaces of these particles by using fatty acid, fatty acid metal salt, silane coupling agent, titanate coupling agent, acrylate resin, phenol resin, cationic or nonionic water-soluble resin, or the like, according to a usual manner.

Component (b) preferably makes up to 20-60% by weight of the composition of the present invention and more preferably 30-60% by weight of the composition based on polymer components, flame retardant filler, and synergist.

The metal phosphonate or metal phosphinate synergist (c) used herein can be any metal phosphonate or phosphinate represented by the formula:

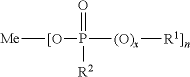

where Me is a metal, R¹ and R² are the same or different linear or branched or cyclic alkyls having up to 6 carbon atoms, or benzyl, n is a metal valency and can be, 1, 2, 3 or 4, x is 1 for metal phosphonates and x is 0 for metal phosphinates.

Metals (Me) which can be present in a metal phosphonate or phosphinate include alkaline earth or transitionary metals such as the non-limiting group consisting of Ca, Zn, Al, Fe, Ti and combinations thereof. The most preferable metal is Al.

In the most preferable embodiment the synergist is an aluminum salt of methyl methylphosphonic acid (AMMP), where X is 1, R¹ and R² is methyl and n=3. AMMP contains a high level (i.e., 26 weight percent) of active phosphorus. AMMP can be synthesized either by reacting dimethyl methylphosphonate with an aqueous solution of sodium hydroxide followed by precipitation with aluminum chloride, or by direct reaction of aluminum hydroxide or anhydrous aluminum chloride with dimethyl methylphosphonate at 180° C. with intensive stirring.

Preferably, the metal salt of alkyl alkylphosphonic acid is represented by a powder with an average particle size of less than about 25 microns, more preferably less than about 10 microns and even more preferably less than about 5 microns. The preferred metal salt of alkyl alkylphosphonic acid according to the present embodiments comprises a plurality of particles having an average size in the range of from about 0.1 microns to about 3 microns. It will be understood that any of the aforementioned average particle size ranges can have a lower end point of from about 0.1 microns.

Preferably, the synergist (c) is present in the flame retarded polyolefin composition in the range from 1 to 25 wt. % and more preferably in the range from 3 to 15 wt. % based on the total weight of the polyolefin polymer composition.

In one embodiment of this invention the inorganic flame retardant filler and the synergist are added to the polyolefin flame retardant formulation in the powder form and then compounded into the thermoplastic polyolefin polymer (a) by known methods.

In another embodiment of the invention the inorganic flame retardant filler (b) and the synergist (c) are premixed together optionally with a binding agent and granulated into concentrates in order to improve handling and in order to decrease dusting.

In even another embodiment of the invention the flame retardant composition of mineral flame retardant filler and metal phosphonate or phosphinate synergist is formed in-situ by partial reaction of mineral flame retardant filler with corresponding reactive agent able to produce the synergist. For example metal phosphonate can be formed by partial reaction of aluminum hydroxide or magnesium hydroxide with the corresponding ester of phosphonic acid. Both metal phosphonate or metal phosphinate can be formed by partial reaction of aluminum hydroxide or magnesium hydroxide with corresponding phosphonic acid or phosphinic acid.

In one preferred embodiment of this invention the aluminum methyl methylphosphonate (AMMP) is formed in-situ by reacting aluminum hydroxide (ATH) with dimethyl methylphosphonate (DMMP) at the temperature of about 170 C for about 40 min. The excess of DMMP is further removed and the product is washed with water and acetone. By using this process a plurality of ATH/AMMP mixtures containing from about 2 wt. % to about 50 wt. % AMMP can be prepared.

In one embodiment herein the flame-retarded polyolefin composition can further optionally comprise an auxiliary phosphate ester. The role of phosphate ester is to improve resin flow and provide additional flame retardancy. The phosphate ester is preferably an aromatic phosphate or bisphosphate.

In one non-limiting embodiment the phosphate ester is selected from the group consisting of triphenyl phosphate, hydroquinone bis(diphenyl phosphate), resorcinol bis(diphenyl phosphate), resorcinol bis(1,6-xylenyl phosphate), 4,4′-biphenol bis(diphenyl phosphate), bisphenol A bis(diphenyl phosphate), bisphenol S bis(diphenyl phosphate), bisphenol F bis(diphenyl phosphate); and, combinations of any of the herein described phosphate esters.

In another embodiment of this invention the flame-retarded polyolefin composition herein can further optionally contain nanofiller, for example organically treated clay or carbon nanotubes.

In even another embodiment of this invention the flame-retarded polyolefin composition can further optionally contain zinc borate, barium borate or calcium borate.

The flame-retarded polyolefin composition may further comprise one or more additional additives which are known in the art, such as, for example, ultraviolet and light stabilizers, UV screeners, UV absorbers, heat stabilizers, antioxidants, dispersing agents, lubricants and combinations thereof.

In the method of the invention, the thermoplastic polyolefin polymer (a), the inorganic flame retardant filler (b) and the metal phosphonate or phosphinate synergist (c) and any other components are blended in the desired quantities and heated to a temperature above the melting point of the polyolefin polymer (a). The heating and blending can be done in either order, however, in the preferred embodiment, these processes are conducted simultaneously. The mixing may be conducted in any suitable equipment including a batch mixer, Banbury mixer, single or twin screw extruder, ribbon blender, injection molding machine, two roll mill or the like.

In one embodiment herein, the flame-retarded polyolefin composition of this invention will show significant decrease of heat release rate and smoke formation as measured in the cone calorimeter test.

Another important characteristic of the flame-retarded polyolefin composition of this invention is that it shows improved integrity of the char obtained in the cone calorimeter test.

### EXAMPLES

### Example 1

200 g aluminum hydroxide (ATH, HT-980, ex. R.J. Marshall Co.) was added to 1200 ml dimethyl methylphosphonate (DMMP) and heated to about 170° C. The reaction mixture was kept at this temperature over a period of 40 min, followed by cooling down to room temperature. The final mixture was filtered and the solid product was washed with water and acetone, and dried at 105° C. The dry product (233 g) has phosphorus content of 5.3% which corresponds to about 20% wt. aluminum methyl methylphosphonate (AMMP).

### Examples 2-7

List of the materials used in these examples are as following:

(a₁)—Ethylene-vinyl acetate copolymer, EVA, Elvax 265, ex. DuPont
(b₁)—Aluminum hydroxide, ATH, HT-980, ex. R.J. Marshall
(b₂)—Magnesium hydroxide, MDH, FR-20-120D-S7, ex. ICL-IP
(b₃)—Aluminum hydroxide treated with DMMP (Example 1)
(c)—Aluminum methyl methylphosphonate, AMMP, ex. ICL-IP

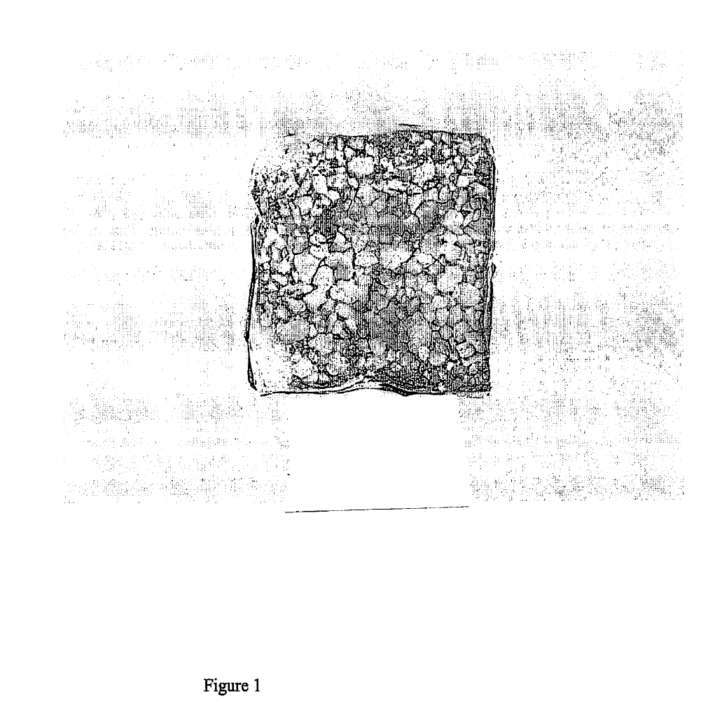

Compounding of EVA compositions was performed on Brabender Intelli-Torque bowl mixer with the chamber volume of 60 cm³ at 190 C with blades speed 60 rpm and duration of mixing 5 minutes. The test specimens 10×10×0.3 cm were prepared by compression molding using a Wabash hydraulic press at 220 C, using force of 4 tons for 4 min. The EVA compositions were tested in Stanton Redcroft Cone calorimeter at 50 kW/m² according to ASTM E 1354 test method. Results of Cone calorimeter test are shown in Table 1. Photographs of the chars obtained after combustion in Cone calorimeter are shown in FIGS. 1-5.

TABLE 1

| | Comp. | Comp. | | | Comp. | |
|---|---|---|---|---|---|---|
| | Ex. 2 | Ex. 3 | Ex. 4 | Ex. 5 | Ex. 6 | Ex. 7 |
| Composition | | | | | | |
| a₁ | 100 | 40 | 40 | 40 | 40 | 40 |
| b₁ | | 60 | 57 | | | |
| b₂ | | | | | 60 | 57 |
| b₃ | | | | 60 | | |
| c | | | 3 | | | 3 |
| Cone calorimeter | | | | | | |
| data | | | | | | |
| Ignition, sec | 25 | 28 | 35 | 21 | 44 | 38 |
| Total heat, MJ/m² | 88 | 64 | 63 | 65 | 68 | 63 |
| ^{a}HRR, kW/m² | 645 | 244 | 147 | 195 | 286 | 183 |
| Peak HRR, kW/m² | 1905 | 460 | 221 | 403 | 381 | 311 |
| Total smoke, m²/m² | 1276 | 1117 | 497 | 1469 | 910 | 799 |

^{a}HRR—heat release rate

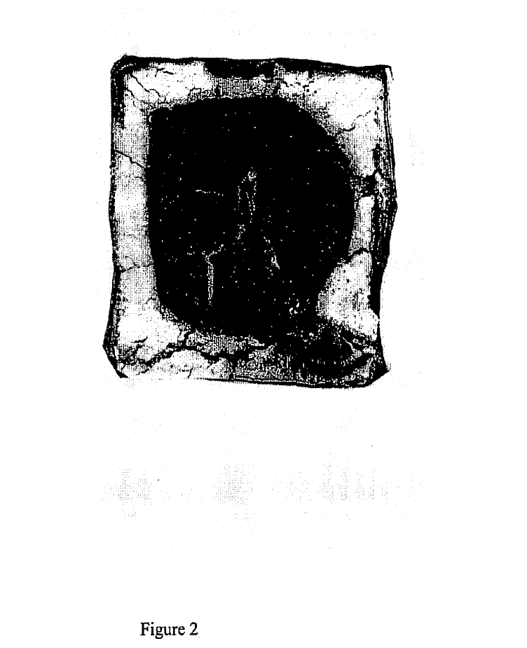

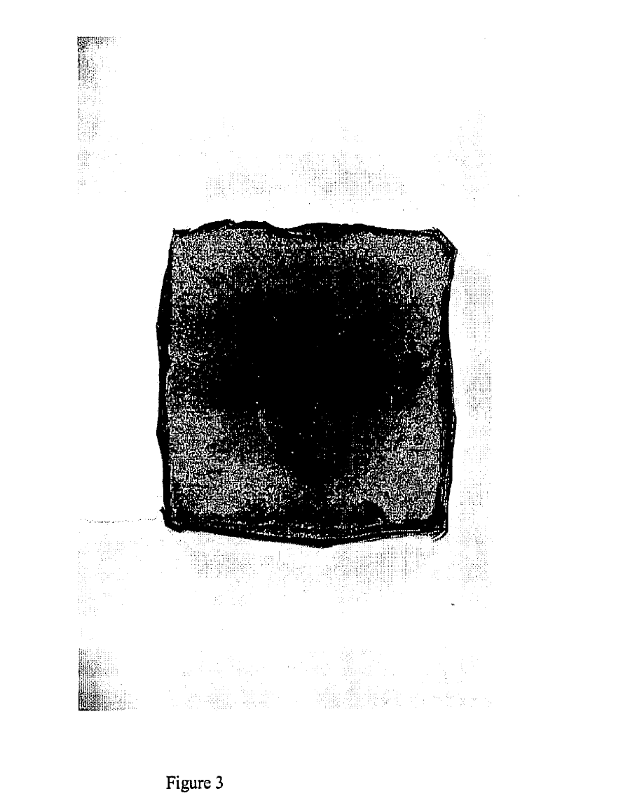

As it is reported in Table 1, aluminum hydroxide (ATH) (comparative example 3) significantly decreases heat release rate (HRR), peak heat release rate (peak HRR) and smoke. The residue shown in FIG. 1 is fluffy white powder, which indicates that it is mostly aluminum oxide. Therefore reduction in HRR and smoke is mostly achieved due to replacement of combustible EVA with incombustible ATH. Unexpectedly, replacement of only 3 wt. % of ATH with AMMP (example 4) resulted in significant decrease of peak HRR and drastic drop in smoke. FIG. 2 shows a picture of a solid residue of this formulation. Black color of the residue is an indication that the polymer (EVA) is involved in the charring which probably led to lower fuel supply to the flame. Surface coating of ATH/AMMP mixture prepared in situ also helps to decrease peak HRR, but smoke increases (example 5) . In this case AMMP helps to produce a very strong ceramic like solid residue after combustion (FIG. 3).

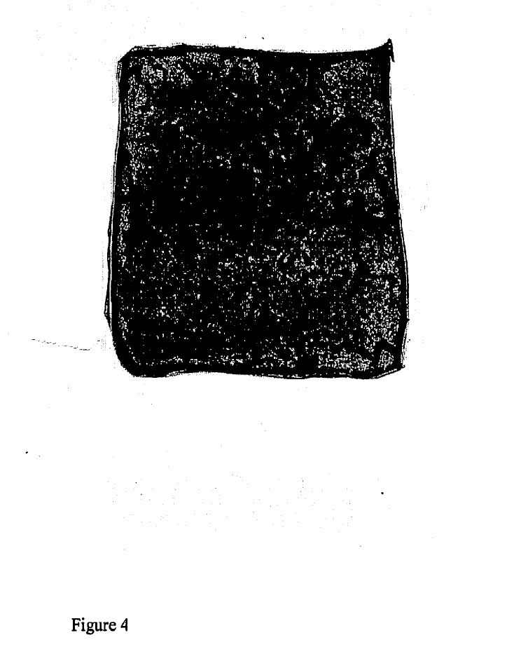

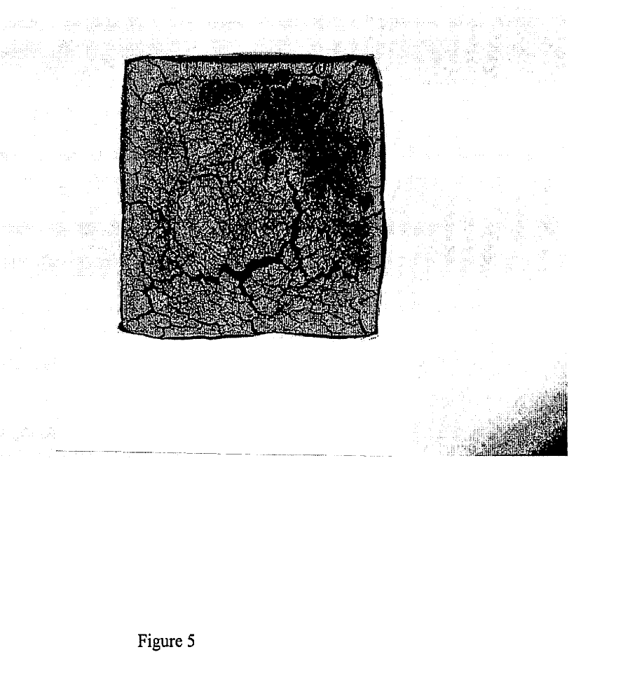

Magnesium hydroxide (MDH) is also efficient flame retardant for EVA which helps in decreasing heat release rate and smoke (comparative example 6) but the solid residue is composed of small cracked plates (FIG. 4). Partial replacement of MDH with 3 wt. % AMMP also leads to further decrease of peak HRR and smoke (Example 7). Furthermore improvement in the ceramic solid residue is observed (FIG. 5).

While the process of the invention has been described with reference to certain embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out the process of the invention but that the invention will include all embodiments falling within the scope of the appended claims.

1. A flame-retarded polyolefin composition comprising (a) thermoplastic polyolefin, (b) an inorganic flame retardant filler and (c) a metal phosphonate or metal phosphinate synergist of the general formula: 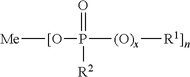
where Me is a metal, R¹ and R² are the same or different linear, branched or cyclic alkyl having up to 6 carbon atoms, or benzyl, n is 1, 2, 3 or 4, and x is 0 or 1.

2. The flame-retarded polyolefin composition of claim 1 wherein the thermoplastic polyolefin (a) is at least one of a polyethylene homopolymer, polyethylene copolymer, polypropylene homopolymer and polypropylene copolymer.

3. The flame-retarded polyolefin composition of claim 2 wherein the polyolefin polymer is at least one of ethylene-vinyl acetate copolymer (EVA); ethylene-propylene rubber (EPR); ethylene-propylene-diene-monomer rubber (EPDM); and, copolymers of ethylene and propylene with butene-1, pentene-1, 3-methylbutene-1, 4-methylpentene-1, octane-1, and mixtures thereof.

4. The flame-retarded polyolefin composition of claim 1 wherein the inorganic flame retardant filler is at least one metal hydroxide selected from the group consisting of aluminum hydroxide, magnesium hydroxide, magnesium basic carbonate, hydrotalcite, calcium aluminate hydrate.

5. The flame-retarded polyolefin composition of claim 1 wherein Me is selected from the group consisting of Ca, Mg, Zn, Al, Fe, Ni, Cr, and Ti.

6. The flame-retarded polyolefin composition of claim 1 wherein metal phosphonate is aluminum methyl methylphosphonate.

7. The flame-retarded polyolefin composition of claim 1 further comprising a flame retardant composition of the mineral flame retardant filler and metal phosphonate or phosphinate synergist wherein the synergist is formed in-situ by partial reaction of mineral flame retardant filler with a corresponding reactive agent able to produce the synergist.

8. The flame retardant composition of claim 7 produced by partial reaction of aluminum hydroxide or magnesium hydroxide with corresponding ester of phosphonic acid

9. The flame retardant composition of claim 8 wherein the ester of phosphonic acid is dimethyl methyl phosphonate.

10. The flame retardant composition of claim 7 produced by partial reaction of aluminum hydroxide or magnesium hydroxide with corresponding phosphonic acid or phosphinic acid.

11. The flame-retarded polyolefin composition of claim 1 wherein inorganic flame retardant filler is present in the range from 20 to 65 percent of the total weight of the composition.

12. The flame-retarded polyolefin composition of claim 1 wherein inorganic flame retardant filler is present in the range from 30 to 60 percent of the total weight of the composition.

13. The flame-retarded polyolefin composition of claim 1 wherein the metal phosphonate or metal phosphinate is present in the range from 1 to 25 percent of the total weight of the composition.

14. The flame-retarded polyolefin composition of claim 1 wherein the metal phosphonate or metal phosphinate is present in the range from 3 to 15 percent of the total weight of the composition.

15. A cable insulation or jacket comprising the flame-retarded polyolefin composition of claim 1.

16. An article selected from the group consisting of tubing, extruded film or sheets useful for construction and building materials, molded automotive parts or electronic part comprising the flame-retarded polyolefin composition of claim 1.

17. A method of making a flame-retarded polyolefin composition comprising:
contacting (a) at least one thermoplastic polyolefin with (b) at least one inorganic flame retardant filler and (c) at least one metal phosphonate or metal phosphinate synergist;
heating the mixture of thermoplastic polyolefin (a) at least one inorganic flame retardant filler (b) and at least one metal phosphonate synergist (c) or phosphinate to above the melting temperature of the thermoplastic polyolefin.
